(19) United States
(12) Patent Application Publication
(10) Pub. No.: US 2025/0262687 A1
(43) Pub. Date: Aug. 21, 2025

(54) CONTROL DEVICE AND LASER PROCESSING DEVICE COMPRISING SAME, AND METHOD FOR CONTROLLING DISPLACEMENT OF PROCESSING START POINT OF LASER EMISSION MECHANISM OF LASER PROCESSING DEVICE

(71) Applicant: FANUC CORPORATION, Yamanashi (JP)

(72) Inventors: Shun TAKARAZAWA, Yamanashi (JP); Kenta YAMAMOTO, Yamanashi (JP)

(21) Appl. No.: 18/857,182

(22) PCT Filed: Apr. 26, 2022
(86) PCT No.: PCT/JP2022/018836

§ 371 Date: Oct. 16, 2024

(51) Int. Cl. B23K 26/08; B23K 26/38

(52) U.S. Cl. CPC B23K 26/0876; B23K 26/38

(57) ABSTRACT

A laser processing device includes a laser emission mechanism emitting laser along a unit vector, and a sensor in the laser emission mechanism. A control device includes: a main controller outputting a driving command based on a program; and a displacement command generator generating a displacement command for displacing the laser emission mechanism using a detected value from the sensor, by generating: an approach command for displacing the laser emission mechanism from a control start position toward a laser irradiation point to a boundary gap point where the sensor starts detection; and a processing start point displacement command for displacing the laser emission mechanism from the boundary gap point to a processing start point within a detection range of the sensor. The processing start point displacement command includes a pose change matching the unit vector at the boundary gap point with a processing vector at the processing start point.

### TECHNICAL FIELD

The present invention relates to a control device for a laser processing device, particularly to a control device having a function of performing movement control to move a laser emission mechanism such as a machining head to a machining start point.

### BACKGROUND ART

A laser processing device such as a laser cutting machine or a laser welding machine can perform predetermined machining by transmitting a machining laser beam output from a laser oscillator to irradiate a workpiece with the machining laser beam, and moving the machining laser beam and the workpiece relative to each other. In such a laser processing device, when the workpiece is irradiated with the machining laser beam, a control operation in which while detecting a distance between the workpiece and a laser emission mechanism such as a machining head using a gap sensor provided in the laser emission mechanism, and while maintaining the detected distance at a predetermined value, laser machining is performed according to a machining program has been known.

As a laser processing device that executes such a control operation, for example, Patent Document 1 discloses a laser processing device configured to rotate a machining nozzle around a predetermined rotation axis and to perform laser machining on a workpiece with a laser beam irradiated from the machining nozzle while moving the machining nozzle relative to the workpiece according to a machining program, the laser processing device including a three-dimensional movement unit that moves the machining nozzle relative to the workpiece in three-dimensional directions; a rotation unit that rotates the machining nozzle around the rotation axis; a gap amount detection unit that detects a gap amount between the machining nozzle and the workpiece; a rotation position detection unit that detects a rotation position of the rotation axis induced by the rotation unit; and a command calculation unit that generates a command signal for maintaining the gap amount constant based on the detected gap amount and rotation position. In the Patent Document 1, the three-dimensional movement unit moves the machining nozzle relative to the workpiece in the three-dimensional directions based on the command signal. According to such a laser processing device, it is possible to reduce errors in the machined shape of the workpiece due to the control of the gap amount.

### CITATION LIST

### Patent Literature

Patent Literature 1: JP 2017-192970 A

### SUMMARY OF THE INVENTION

### Problem to be Solved by the Invention

As described above, in a case where laser machining is performed while performing trace control to keep the gap amount between the machining nozzle and the workpiece constant based on a detection value from the gap amount detection unit, when machining is started, an approach operation in which a laser emission mechanism is brought closer to a detection range, in which the gap amount detection unit may detect the gap amount, from a predetermined control start point, a rotation operation in which the laser emission mechanism is rotated around a predetermined rotation axis (B-axis), and a correction operation in which the position of a unit vector after the rotation (a vector defined with a nozzle tip in a direction along a central axis of the laser emission mechanism as a starting point) is corrected are executed. Further, after the correction operation, machining control of the laser machining is executed based on the machining program.

In the series of operations described above, in the approach operation, for example, position control is executed to move the laser emission mechanism closer to the workpiece based on the control start point. Meanwhile, in the correction operation, a correction movement amount of the machining nozzle is grasped with an intersection point between the workpiece and the central axis of the machining nozzle as a reference position, and position control is executed to move the position of the nozzle tip from the intersection point in the direction of the unit vector according to the correction movement amount.

In this case, in a control device that controls the operation of the laser processing device, the reference position for the position control that moves the laser emission mechanism is the control start point in the approach operation, whereas the reference position for the correction operation is the intersection point between the workpiece and the central axis of the machining nozzle. For this reason, when a transition is made from the approach operation to the correction operation, the control device needs to calculate a position of the laser emission mechanism related to the position control in the correction operation after obtaining the reference position of a control command, so that there is a problem that the calculation load increases and a time lag occurs during a transition to the correction operation.

For these reasons, there is a demand for the control device capable of reducing the load of calculating a movement position of the laser emission mechanism included in a movement command when trace control is performed to keep the distance between the workpiece and the laser emission mechanism constant based on the detection value from the gap sensor in movement control that moves the laser emission mechanism (for example, a machining head) to a machining start point.

### Means for Solving Problem

A control device according to one aspect of the invention to control an operation of a laser processing device including a laser emission mechanism for emitting a machining laser beam in a direction along a unit vector and a gap sensor provided in the laser emission mechanism comprises: a main control unit to output a drive command to components of the laser processing device based on a machining program; and a movement command generation unit to generate a movement command for moving the laser emission mechanism using a detection value from the gap sensor. The movement command generation unit has a function of generating an approach command for moving the laser emission mechanism from a control start position toward a laser irradiation point on a workpiece to a boundary gap point where the gap sensor starts a detection, and a machining start point movement command for moving the laser emission mechanism from the boundary gap point to a machining start point within a detection range of the gap sensor. The machining start point movement command includes a posture change for causing the unit vector at the boundary gap point to coincide with a machining vector at the machining start point.

In addition, a laser processing device according to another aspect of the present invention to perform laser machining by irradiating a workpiece with a machining laser beam comprises: a laser oscillator to oscillate the machining laser beam; a workpiece holding mechanism for holding the workpiece; a laser emission mechanism for irradiating the machining laser beam in a direction along a unit vector; a gap sensor provided in the laser emission mechanism; a transport mechanism for moving the laser emission mechanism relative to the workpiece holding mechanism; and a control device to control an operation of each component of the laser processing device. The control device further comprises a main control unit to output a drive command to each component of the laser processing device based on a machining program, and a movement command generation unit to generate a movement command for moving the laser emission mechanism using a detection value from the gap sensor. The movement command generation unit has a function of generating an approach command for moving the laser emission mechanism from a control start position toward a laser irradiation point on the workpiece to a boundary gap point where the gap sensor starts a detection, and a machining start point movement command for moving the laser emission mechanism from the boundary gap point to a machining start point within a detection range of the gap sensor. The machining start point movement command includes a posture change for causing the unit vector at the boundary gap point to coincide with a machining vector at the machining start point.

Further, a machining start point movement control method according to another aspect of the present invention for a laser emission mechanism which moves the laser emission mechanism of a laser processing device including the laser emission mechanism for emitting a machining laser beam in a direction along a unit vector and a gap sensor provided in the laser emission mechanism to a machining start point of trace machining control includes: an approach routine for moving the laser emission mechanism from a control start position toward a laser irradiation point on a workpiece to a boundary gap point where the gap sensor starts a detection; and a machining start point movement routine for moving the laser emission mechanism from the boundary gap point to the machining start point within a detection range of the gap sensor. The machining start point movement routine includes a posture change step of causing the unit vector at the boundary gap point to coincide with a machining vector at the machining start point.

### Effect of the Invention

According to one aspect of the present invention, the movement command generation unit has a function of generating an approach command for moving the laser emission mechanism from the control start position to the boundary gap point, and a machining start point movement command for moving the laser emission mechanism from the boundary gap point to the machining start point, and is configured to calculate the machining start point movement command based on the coordinate values and the vector of the boundary gap point, so that in movement control that moves the laser emission mechanism to the machining start point, the load of calculating a movement position of the laser emission mechanism included in the movement command can be reduced.

### BRIEF DESCRIPTION OF DRAWINGS

FIG. 1 is a schematic view showing a configuration of a laser processing device including a control device according to a first embodiment;

FIG. 2 is a block diagram showing one example of the configuration of the laser processing device shown in FIG. 1;

FIG. 3 is a flowchart showing an outline of a machining start point movement control method executed by the control device in the laser processing device according to the first embodiment;

FIG. 4 is a flowchart showing an outline of an approach routine shown in FIG. 3;

FIG. 5 is a flowchart showing an outline of a machining start point movement routine shown in FIG. 3;

FIG. 6A is a partial front view showing an outline of a positional relationship between a laser emission mechanism and a workpiece when the approach routine is started;

FIG. 6B is a partial front view showing an outline of a positional relationship between the laser emission mechanism and the workpiece when the approach routine is ended;

FIG. 6C is a partial front view showing an outline of a positional relationship between the laser emission mechanism and the workpiece when the machining start point movement routine is started;

FIG. 6D is a partial front view showing an outline of a positional relationship between the laser emission mechanism and the workpiece when the machining start point movement routine is ended;

FIG. 7 is a flowchart showing an outline of a machining start point movement routine in a machining start point movement control method executed by a control device according to a second embodiment that is another example of the invention;

FIG. 8 is a partial front view showing an outline of a distance correction operation of the laser emission mechanism in the machining start point movement routine according to the second embodiment; and

FIG. 9 is a flowchart showing an outline of a machining start point movement routine in a machining start point movement control method executed by a control device according to a third embodiment that is still another example of the invention.

### MODE(S) FOR CARRYING OUT THE INVENTION

Hereinafter, embodiments of a laser processing device including a control device according to one typical example of the present invention and a machining start point movement control method of a laser emission mechanism (for example, a machining head) in the laser processing device will be described with reference to the drawings.

### First Embodiment

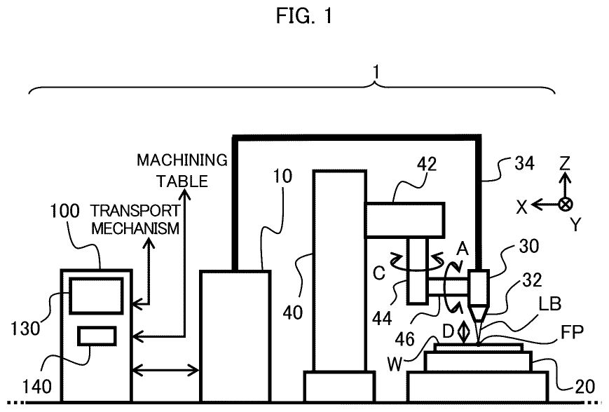

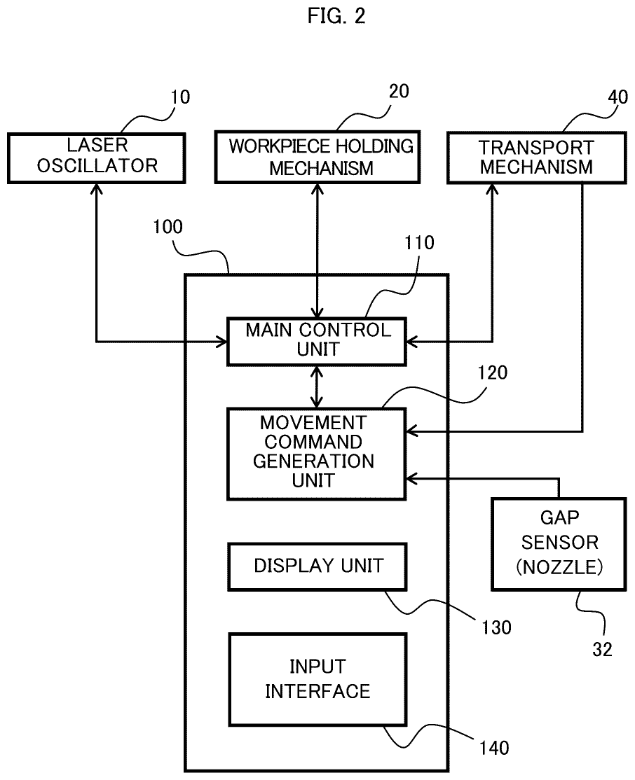

FIG. 1 is a schematic view showing a configuration of a laser processing device including a control device according to a first embodiment that is one typical example of the present invention. In addition, FIG. 2 is a block diagram showing one example of the configuration of the laser processing device shown in FIG. 1.

As shown in FIG. 1, a laser processing device 1 includes, as one example, a laser oscillator 10 that oscillates a machining laser beam LB; a workpiece holding mechanism 20 that holds a workpiece W; a laser emission mechanism (for example, a machining head) 30 that emits the machining laser beam LB to the workpiece W; a transport mechanism 40 that moves the laser emission mechanism 30 relative to the workpiece holding mechanism 20; and a control device 100 that controls a predetermined laser machining operation on the workpiece W.

The laser processing device in this specification can be applied as, for example, any machining apparatus that executes predetermined machining such as laser welding, laser cutting, laser drilling (trepanning), laser marking, laser dicing, or laser annealing by irradiating the workpiece W with a machining laser beam.

As the laser oscillator 10, a laser oscillation source having a wavelength with high absorption efficiency is applied depending on the material of the workpiece W to be machined. Lasers capable of fiber transmission, such as a YAG laser, a YVO₄ laser, a fiber laser, and a disk laser, can be provided as examples of the laser oscillator 10. In addition, the machining laser beam LB output from the laser oscillator 10 is transmitted to the laser emission mechanism 30 via, for example, a transmission path 34 such as an optical fiber.

The workpiece holding mechanism 20 includes, as one example, a chuck mechanism (not shown) for attaching the workpiece W, and is configured as a machining table that is movable in XYZ three-axis directions shown in the figure while gripping and fixing the workpiece W. In addition, the workpiece holding mechanism 20 may include, for example, not only a mechanism for moving the workpiece W in the three-axis directions, but also a rotation mechanism (for example, a configuration known as a B-axis along a Y-axis and a C-axis along a Z-axis).

The laser emission mechanism 30 is, as one example, configured as a machining head to which the machining laser beam LB is introduced from one end (upper end) side via the transmission path 34 such as an optical fiber, and which emits the machining laser beam LB from a nozzle 32 on the other end (lower end) side toward the workpiece W. In this case, the machining laser beam LB is focused to a predetermined beam diameter at a laser irradiation point FP on the workpiece W by a focusing lens (not shown) disposed inside the laser emission mechanism 30.

In the present invention, the nozzle 32 has a function as a gap sensor that detects a distance D between a lower end of the laser emission mechanism 30 (nozzle 32) and the workpiece W, in addition to a function as an emission port for the machining laser beam LB in the laser emission mechanism 30. A capacitance sensor can be applied as one example of the nozzle 32.

Incidentally, in the example shown in FIG. 1, a case where the nozzle 32 is configured as a part of an electrode of the capacitance sensor is provided as an example; however, as described above, any sensor is applicable as long as the sensor can detect a gap between the workpiece W and the laser emission mechanism 30, and such a sensor may be configured to be directly attached to the laser emission mechanism 30. In this case, for example, a method for specifying a distance between the laser emission mechanism 30 and the workpiece W by providing a reference point for position measurement at a part of the laser emission mechanism 30 and correcting a distance measured by the sensor using a relative position between the reference point and the sensor can be adopted.

The transport mechanism 40 includes, as one example, a linear drive unit 42 that moves relatively in the XYZ three-axis directions orthogonal to each other; a first arm 44 that rotates around the C-axis extending along the Z-axis from a lower surface of the linear drive unit 42; and a second arm 46 of which one end is attached orthogonally to the first arm and which rotates around an A-axis extending in an XY plane. Further, the laser emission mechanism 30 is attached to the other end of the second arm 46, and accordingly, the laser emission mechanism 30 is rotatable around the A-axis.

As shown in FIG. 2, the control device 100 includes, as one example, a main control unit 110 that outputs a drive command to components of the laser processing device 1 to be described later, based on a machining program; a movement command generation unit 120 that generates a movement command for moving the laser emission mechanism 30 using a detection value from the gap sensor (nozzle 32); a display unit 130 that displays various parameters and the like; and an input interface 140 that allows manual input of information for modifying the machining program or various parameters. Further, in the control device 100, the main control unit 110 is connected to the laser oscillator 10, the workpiece holding mechanism 20, and the transport mechanism 40 by wire or wirelessly, and controls the overall operation of the laser processing device 1 by exchanging signals with these peripheral devices.

The main control unit 110 has, as one example, a function of extracting information on a machining route, machining conditions, or the like from the machining program and outputting an output command signal for instructing the output of the machining laser beam LB to the laser oscillator 10. In addition, the main control unit 110 also has a function of extracting information on a position of the irradiation point FP of the machining laser beam LB or a position of the laser emission mechanism 30, machining vectors to be described later, and the like from the machining program, and outputting a machining position command signal for instructing a relative movement between the workpiece W and the laser emission mechanism 30 to the workpiece holding mechanism 20 and the transport mechanism 40.

The movement command generation unit 120 has a function of generating an approach command for moving the laser emission mechanism 30 from a control start position toward the laser irradiation point on the workpiece to a boundary gap point where the gap sensor starts detection, and a machining start point movement command for moving the laser emission mechanism from the boundary gap point to a machining start point within the detection range of the gap sensor. As one example, each of the approach command and the machining start point movement command generated by the movement command generation unit 120 is sent to the main control unit 110, and is converted into an individual drive command for each component of the laser processing device 1 in the main control unit 110, and the individual drive command is output.

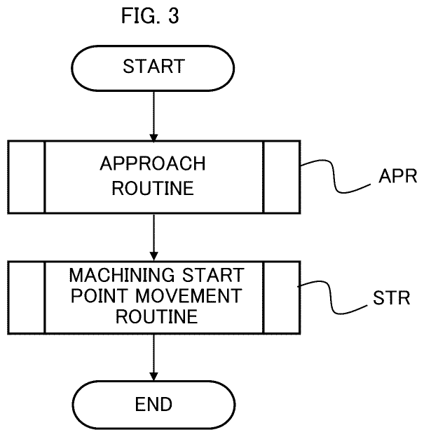

Next, a specific operation mode of the machining start point movement control method executed by the control device for the laser processing device according to the first embodiment will be described with reference to FIGS. 3 to 6.

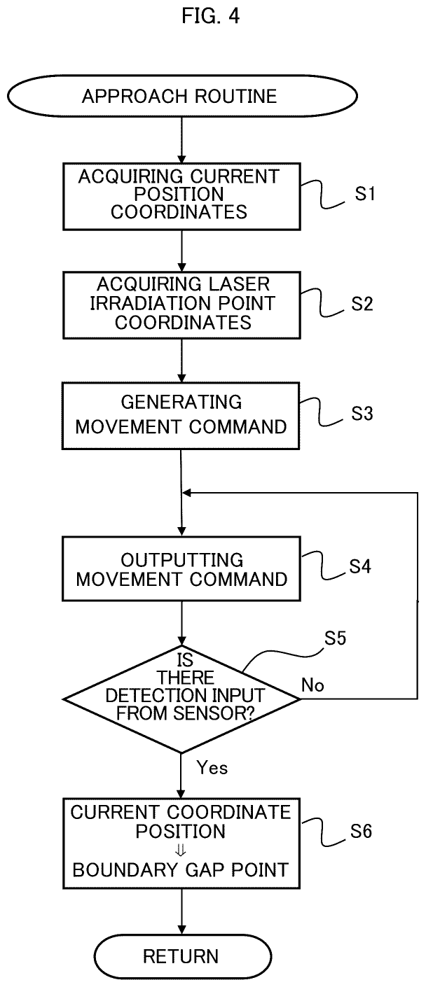

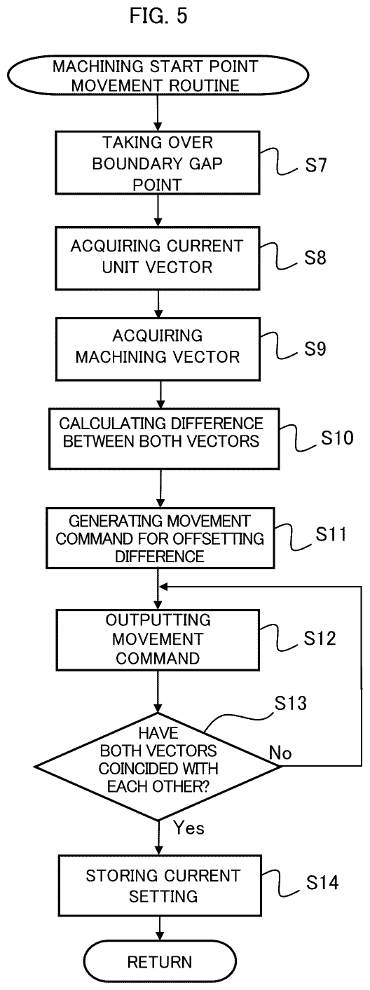

FIG. 3 is a flowchart showing an outline of the machining start point movement control method executed by the control device in the laser processing device according to the first embodiment. In addition, FIG. 4 is a flowchart showing an outline of an approach routine shown in FIG. 3. In addition, FIG. 5 is a flowchart showing an outline of a machining start point movement routine shown in FIG. 3.

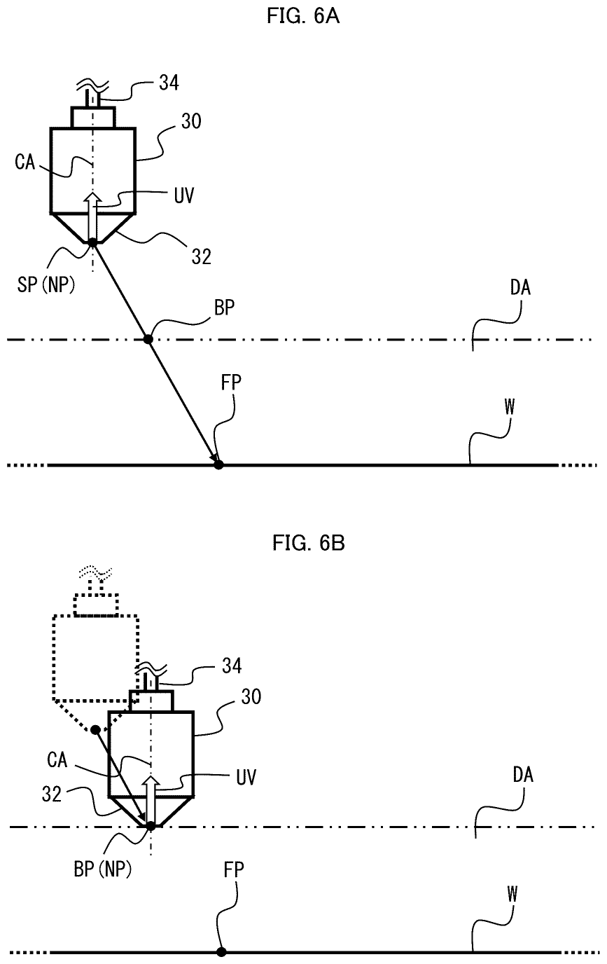

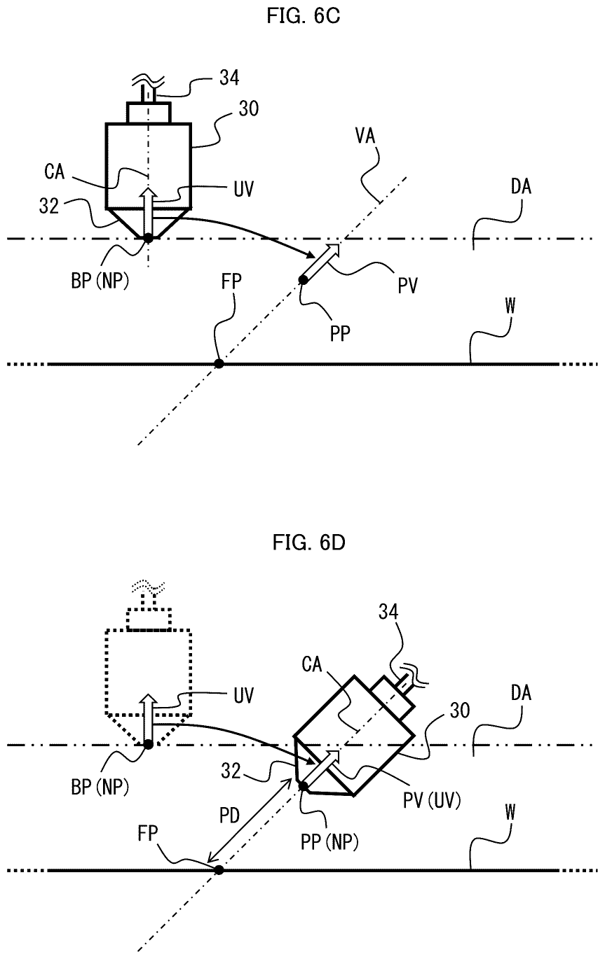

Furthermore, FIG. 6A is a partial front view showing an outline of a positional relationship between the laser emission mechanism and the workpiece when the approach routine is started. In addition, FIG. 6B is a partial front view showing an outline of a positional relationship between the laser emission mechanism and the workpiece when the approach routine is ended. In addition, FIG. 6C is a partial front view showing an outline of a positional relationship between the laser emission mechanism and the workpiece when the machining start point movement routine is started. In addition, FIG. 6D is a partial front view showing an outline of a positional relationship between the laser emission mechanism and the workpiece when the machining start point movement routine is ended.

Incidentally, in the following description, the “position” or “point” of the laser emission mechanism 30 refers to the entirety of the laser emission mechanism 30 being represented as a single point, and a center point of the emission port of the nozzle 32 (for example, a nozzle tip point NP that is an intersection point between a tip of the nozzle 32 and a central axis CA in FIGS. 6A to 6D) is adopted as the “position” or “point”. In addition, an angle between a line passing through a machining start point PP and the laser irradiation point FP and a normal to the workpiece W at the laser irradiation point FP is defined as an “inclination angle θ” of the laser emission mechanism 30.

Furthermore, a “unit vector UV” of the laser emission mechanism 30 is defined as a vector having a predetermined length in a direction along the central axis of the laser emission mechanism 30, with the above-described nozzle tip point NP of the laser emission mechanism 30 as a starting point. In addition, a “machining vector PV” is defined as a vector having the same length as the unit vector UV in a direction along the above-described line passing through the machining start point PP and the laser irradiation point FP (namely, in the same direction as the above-described inclination angle θ) with the machining start point PP as a starting point. By defining these vectors, a displacement amount (correction amount) can be calculated by multiplying the difference between detection values obtained from the gap sensor.

The machining start point movement control method for moving the laser emission mechanism 30 from a control start point (control start position) SP to the machining start point PP, which is executed when laser machining is performed by the laser processing device 1 according to the present invention, includes, as shown in FIG. 3, an approach routine APR for moving the laser emission mechanism 30 from the control start point SP toward the laser irradiation point FP on the workpiece W to a boundary gap point BP where the gap sensor starts detection, and a machining start point movement routine STR for moving the laser emission mechanism 30 from the boundary gap point BP to the machining start point PP. Incidentally, between the approach routine APR and the machining start point movement routine STR, in addition to information on the position or posture of the laser emission mechanism 30 related to the laser machining, information on a machining condition such as the output, speed, or the like of the machining laser beam LB is also taken over.

In the approach routine APR, as shown in FIG. 4 as one example, the main control unit 110 acquires, for example, information on the current position coordinates of the nozzle tip point NP in the laser emission mechanism 30 from the transport mechanism 40 (step S1), and sets the position coordinates as the control start point SP. Next, for example, the main control unit 110 analyzes the machining program to acquire the irradiation position coordinates (laser irradiation point FP) of the machining laser beam LB on the workpiece W (step S2). One example of the positional relationship between the laser emission mechanism 30 and the workpiece W in this case is shown in FIG. 6A.

Subsequently, the main control unit 110 sends data of the control start point SP and the laser irradiation point FP that are acquired, to the movement command generation unit 120, and the movement command generation unit 120 that has received the data generates an approach command for the transport mechanism 40 to move linearly between the control start point SP and the laser irradiation point FP from the coordinate values of the control start point SP and the laser irradiation point FP. Then, the movement command generation unit 120 sends the generated approach command to the main control unit 110 (step S3).

Subsequently, the main control unit 110 outputs an approach command to the transport mechanism 40 (step S4), and determines whether a detection signal has been input from the gap sensor (namely, whether the nozzle tip point NP has entered a detectable region DA by the gap sensor at a predetermined distance from the surface of the workpiece W shown in FIG. 6A) at each predetermined control clock (step S5).

In step S5, when it is determined that a detection signal has not been input from the gap sensor, the main control unit 110 returns to step S4, and continues outputting the approach command again. Accordingly, an approach operation of the laser emission mechanism 30 to the workpiece W is repeatedly executed until the gap sensor starts to detect a gap value (namely, until the gap sensor starts to output a detection signal). In this case, a movement speed of the laser emission mechanism 30 in the approach operation may be set to be larger than that in a machining start point movement operation to be described later.

On the other hand, in step S5, when it is determined that a detection signal has been input from the gap sensor, the main control unit 110 receives the current coordinate values of the nozzle tip point NP in the laser emission mechanism 30 from the transport mechanism 40, stores the coordinate values as the “boundary gap point BP” where the nozzle tip point NP is located at the boundary of the detectable region DA (step S6), and ends the approach routine. One example of the positional relationship between the laser emission mechanism 30 and the workpiece W in this case is shown in FIG. 6B.

Next, in the machining start point movement routine STR, as shown in FIG. 5 as one example, the main control unit 110 takes over information on the boundary gap point BP from the approach routine APR (step S7), and acquires, for example, the unit vector UV from the transport mechanism 40 based on the current position coordinates of the nozzle tip point NP in the laser emission mechanism 30 and the central axis CA (step S8). Subsequently, for example, the main control unit 110 analyzes the machining program to define an imaginary beam axis VA based on the laser irradiation point FP on the workpiece W and the nozzle tip point NP (namely, the machining start point PP) of the laser emission mechanism 30 when machining is started, and acquires the machining vector PV in a direction along the virtual beam axis VA (step S9).

Subsequently, the main control unit 110 sends data of the current unit vector UV and the machining vector PV at the machining start point PP that are acquired, to the movement command generation unit 120, and the movement command generation unit 120 that has received the data calculates a difference as a vector between the unit vector UV and the machining vector PV (step S10), and generates a machining start point movement command including a coordinate movement and a posture change of the laser emission mechanism 30 to offset the difference (namely, to cause starting points and directions of the unit vector UV and the machining vector PV to coincide with each other). Then, the movement command generation unit 120 sends the generated machining start point movement command to the main control unit 110 (step S11). One example of a positional relationship between the unit vector UV of the laser emission mechanism 30 and the machining vector PV at the machining start point PP in this case is shown in FIG. 6C.

Subsequently, the main control unit 110 outputs the machining start point movement command to the transport mechanism 40 (step S12), and determines whether the unit vector UV and the machining vector PV have coincided with each other (namely, whether the angle of the current nozzle tip point NP and the central axis CA of the laser emission mechanism 30 has coincided with the machining start point PP and the imaginary beam axis VA) at each predetermined control clock (step S13).

In step S13, when it is determined that the current unit vector UV has not coincided in position and direction with the machining vector PV, the main control unit 110 returns to step S12, and continues outputting the machining start point movement command again. Accordingly, the machining start point movement operation of the laser emission mechanism 30 is repeatedly executed until the unit vector UV coincides with the machining vector PV, namely, until the laser emission mechanism 30 assumes a designated posture (to be taken) at the machining start point PP in the machining program.

On the other hand, in step S13, when it is determined that the current unit vector UV has coincided in position and direction with the machining vector PV, the main control unit 110 stores information for control including the current coordinate values of the nozzle tip point NP of the laser emission mechanism 30 and the posture (inclination angle θ) of the central axis CA as a “current setting” (step S14), and ends the machining start point movement routine. One example of the positional relationship between the laser emission mechanism 30 and the workpiece W in this case is shown in FIG. 6D. Accordingly, when laser machining is started, the movement control of the laser emission mechanism 30 from the control start point SP shown in FIG. 6A to the machining start point PP ends, and the laser emission mechanism 30 is positioned at the machining start point PP spaced away by a predetermined distance PD from the laser irradiation point FP.

Due to including the above-described configuration, in the control device for the laser processing device and the machining start point movement control method according to the first embodiment, the movement command generation unit has a function of generating an approach command for moving the laser emission mechanism from the control start position to the boundary gap point, and a machining start point movement command for moving the laser emission mechanism from the boundary gap point to the machining start point, and is configured to calculate the machining start point movement command based on the coordinate values and the vector of the boundary gap point, so that in the movement control that moves the laser emission mechanism to the machining start point, the load of calculating a movement position of the laser emission mechanism included in the movement command can be reduced.

Incidentally, the laser processing device including the control device according to the first embodiment of the present invention provided above as an example executes movement control to move the laser emission mechanism to the machining start point, and then executes trace machining control to move the laser emission mechanism using a generally known gap sensor such that the distance between the laser emission mechanism and the workpiece is kept constant. Namely, the control device according to the first embodiment is configured to have a function of executing the above-described movement control to move the laser emission mechanism to the machining start point, in addition to a function of causing the laser processing device to execute trace machining control.

### Second Embodiment

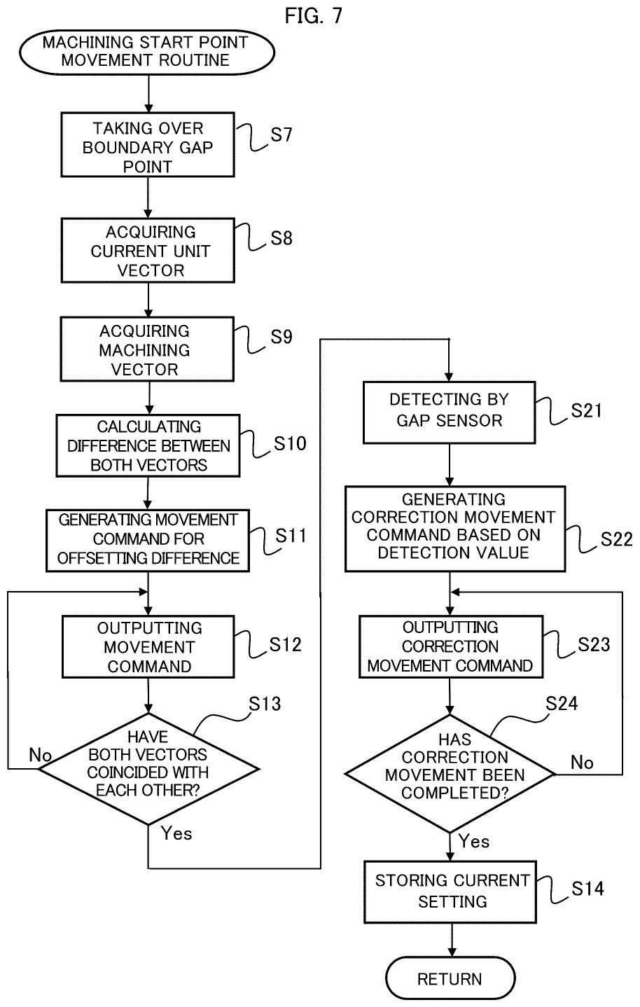

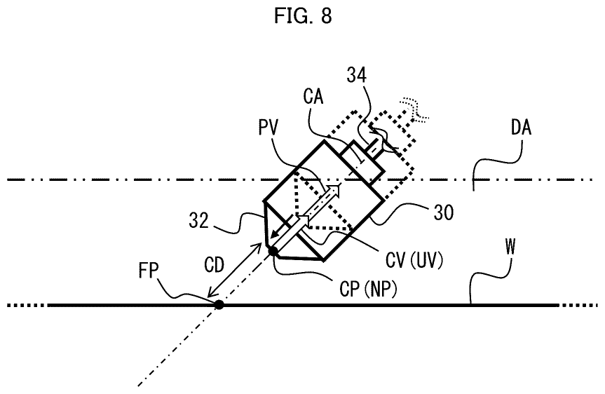

FIG. 7 is a flowchart showing an outline of a machining start point movement routine in a machining start point movement control method executed by a control device according to a second embodiment that is another example of the present invention. In addition, FIG. 8 is a partial front view showing an outline of a distance correction operation of the laser emission mechanism in the machining start point movement routine according to the second embodiment. Incidentally, in the second embodiment, in the schematic views and the like shown in FIGS. 1 to 6, components that can adopt the same or common configurations as those in the first embodiment are denoted by the same letters or numerals, and repeated descriptions thereof will be omitted.

As shown in FIG. 7, in the machining start point movement routine according to the second embodiment, the main control unit 110 and the movement command generation unit 120 execute the same operations as those shown in FIG. 5 in the first embodiment as operations from step S7 to step S12. Subsequently, similarly to the case of the first embodiment, the main control unit 110 determines whether the unit vector UV and the machining vector PV have coincided with each other at each predetermined control clock (step S13).

Then, in step S13, when it is determined that a current unit vector CV (UV) has not coincided in position and direction with the machining vector PV, similarly to the first embodiment, the main control unit 110 returns to step S12, and continues outputting a machining start point movement command again. Accordingly, the machining start point movement operation of the laser emission mechanism 30 is repeatedly executed until the unit vector CV coincides with the machining vector PV.

In a case where laser machining is performed while controlling the distance between the laser emission mechanism 30 and the workpiece W using the gap sensor, when laser machining is actually performed at the machining start point PP, an operation may be executed to correct a focusing position (focal distance) of the machining laser beam LB in the direction of the central axis CA of the laser emission mechanism 30 such that the focusing position is at an appropriate position, based on a detection value from the gap sensor. Therefore, in the second embodiment, after the laser emission mechanism 30 is moved to the machining start point PP on the machining program, the above-described distance correction operation in the direction of the central axis CA is executed.

Namely, in step S13, when it is determined that the current unit vector CV has coincided in position and direction with the machining vector PV, the main control unit 110 acquires a current detection value of the gap sensor (step S21), and sends information on a gap value, which is based on the acquired detection value and the focal distance in the machining program, to the movement command generation unit 120. The movement command generation unit 120 that has received the information further calculates a difference between the gap value calculated from the detection value by the gap sensor and the gap value based on the machining program described above, and generates a correction movement command for moving the laser emission mechanism 30 in a direction along the unit vector CV (namely, the direction along the central axis CA) in order to correct the difference. Then, the movement command generation unit 120 sends the generated correction movement command to the main control unit 110 (step S22).

Subsequently, the main control unit 110 outputs the correction movement command to the transport mechanism 40 (step S23), and determines whether the correction movement has been completed (namely, whether the current nozzle tip point NP has coincided with a correction point CP) at each predetermined control clock (step S24).

In step S24, when it is determined that the correction movement operation has not been completed, the main control unit 110 returns to step S23, and continues outputting the correction movement command again. Accordingly, the correction movement operation of the laser emission mechanism 30 is repeatedly executed until the position of the nozzle tip point NP of the laser emission mechanism 30 coincides with the correction point CP.

On the other hand, in step S24, when it is determined that the correction movement operation has been completed, the main control unit 110 stores information for control including the coordinate values of the nozzle tip point NP (namely, the correction point CP) of the laser emission mechanism 30 and the posture (inclination angle θ) of the central axis CA after the correction as a “current setting” (step S14), and ends the machining start point movement routine. One example of the positional relationship between the laser emission mechanism 30 and the workpiece W resulting from the series of correction operations is shown in FIG. 8. Accordingly, when laser machining is started, an operation is executed to correct the position of the laser emission mechanism 30 in the direction of the central axis CA based on the detection value from the gap sensor, and to set a distance between the laser emission mechanism 30 and the laser irradiation point FP as a correction distance CD.

Due to including the above-described configuration, in the control device for the laser processing device and the machining start point movement control method according to the second embodiment, in addition to the effects described in the first embodiment, a correction operation is executed to correct the position of the laser emission mechanism in the direction along the unit vector such that the machining laser beam has an appropriate focal distance at the machining start point, so that more precise movement control of the laser emission mechanism to the machining start point can be performed.

### Third Embodiment

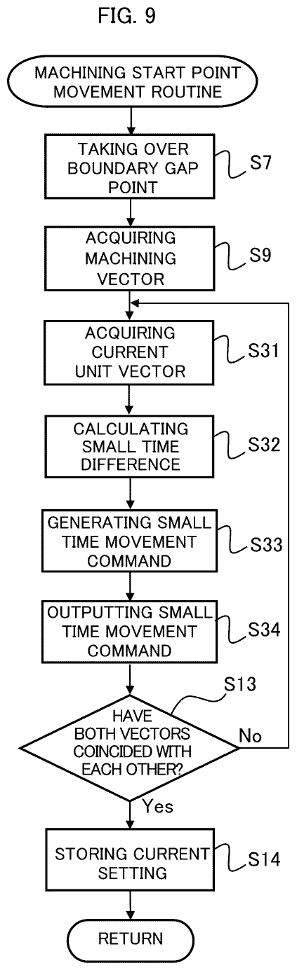

FIG. 9 is a flowchart showing an outline of a machining start point movement routine in a machining start point movement control method executed by a control device according to a third embodiment that is still another example of the present invention. Incidentally, in the third embodiment as well, in the schematic views and the like shown in FIGS. 1 to 8, components that can adopt the same or common configurations as those in the first embodiment and the second embodiment are denoted by the same letters or numerals, and repeated descriptions thereof will be omitted.

The third embodiment is characterized in that, compared to the example shown in the first embodiment, a generation operation of the movement command for the laser emission mechanism 30 by the movement command generation unit 120 and a command output operation for the transport mechanism 40 and the like by the main control unit 110 are executed in parallel at the same time. Namely, as shown in FIG. 9, in the machining start point movement routine according to the third embodiment, the main control unit 110 takes over information on the boundary gap point BP from the approach routine APR (step S7), and acquires the machining vector PV similarly to the case of the first embodiment (step S9).

Subsequently, for example, the main control unit 110 acquires the unit vector UV from the transport mechanism 40 based on the current position coordinates of the nozzle tip point NP in the laser emission mechanism 30 and the central axis CA (step S31). Subsequently, the main control unit 110 sends data of the current unit vector UV and the machining vector PV that are acquired, to the movement command generation unit 120, and the movement command generation unit 120 that has received the data calculates a small time difference as a vector between the unit vector UV and the machining vector PV per small unit time based on the predetermined control clock (step S32), and generates a small time movement command including a coordinate movement and a posture change of the laser emission mechanism 30 for offsetting the small time difference. Then, the movement command generation unit 120 sends the generated small time movement command to the main control unit 110 (step S33).

Subsequently, the main control unit 110 outputs the small time movement command to the transport mechanism 40 (step S34), and determines whether the unit vector UV and the machining vector PV have coincided with each other at each predetermined control clock described above (step S13).

In step S13, when it is determined that the current unit vector UV has not coincided in position and direction with the machining vector PV, the main control unit 110 returns to step S31, acquires the current unit vector UV again, and executes the operations from step S32 to step S34 thereafter. Accordingly, the movement operation of the laser emission mechanism 30 is repeatedly executed at each small unit time until the unit vector UV coincides with the machining vector PV.

On the other hand, in step S13, when it is determined that the current unit vector UV has coincided in position and direction with the machining vector PV, similarly to the first embodiment, the main control unit 110 stores information for control including the current coordinate values of the nozzle tip point NP of the laser emission mechanism 30 and the posture (inclination angle θ) of the central axis CA as a “current setting” (step S14), and ends the machining start point movement routine. Accordingly, when laser machining is started, the movement control of the laser emission mechanism 30 from the control start point SP to the machining start point PP shown in FIG. 6A ends.

Incidentally, in the operation of calculating the small time difference shown in step S32, for example, the small time difference can be calculated as a maximum movement amount by which the laser emission mechanism 30 can advance toward the machining start point PP per unit time on a line connecting the current nozzle tip point NP (the boundary gap point BP when control is started) and the machining start point PP. In addition, a movement amount of the laser emission mechanism 30 per unit time may be determined in advance, and the movement amount may be determined as a movement amount from the current nozzle tip point NP on the above-described line connecting the current nozzle tip point NP and the machining start point PP.

Due to including the above-described configuration, in the control device for the laser processing device and the machining start point movement control method according to the third embodiment, in addition to the effects described in the first embodiment, a generation operation of the movement command for the laser emission mechanism by the movement command generation unit and a command output operation for the transport mechanism and the like by the main control unit are executed in parallel at the same time, so that the overall control time can be reduced compared to when a command is output after a movement command is generated.

Incidentally, the invention is not limited to the embodiments, and can be changed as appropriate without departing from the concept of the invention. In the invention, any component of the embodiments can be changed, or any component of the embodiments can be omitted within the scope of the invention. For example, the specific examples shown in the first to third embodiments may be applied in combination of respective characteristics.

### EXPLANATIONS OF LETTERS OR NUMERALS

1 LASER PROCESSING DEVICE
10 LASER OSCILLATOR
20 WORKPIECE HOLDING MECHANISM
30 LASER EMISSION MECHANISM (MACHINING HEAD)
32 NOZZLE
34 TRANSMISSION PATH
40 TRANSPORT MECHANISM
42 LINEAR DRIVE UNIT
44 FIRST ARM
46 SECOND ARM
100 CONTROL DEVICE
110 MAIN CONTROL UNIT
120 MOVEMENT COMMAND GENERATION UNIT
130 DISPLAY UNIT
140 INPUT INTERFACE

1. A control device to control an operation of a laser processing device including a laser emission mechanism for emitting a machining laser beam in a direction along a unit vector and a gap sensor provided in the laser emission mechanism, the control device comprising:
a main control unit to output a drive command to components of the laser processing device based on a machining program; and
a movement command generation unit to generate a movement command for moving the laser emission mechanism using a detection value from the gap sensor,
wherein the movement command generation unit has a function of generating an approach command for moving the laser emission mechanism from a control start position toward a laser irradiation point on a workpiece to a boundary gap point where the gap sensor starts a detection, and a machining start point movement command for moving the laser emission mechanism from the boundary gap point to a machining start point within a detection range of the gap sensor, and
the machining start point movement command includes a posture change for causing the unit vector at the boundary gap point to coincide with a machining vector at the machining start point.

2. The control device according to claim 1,
wherein the machining start point movement command further includes a distance correction for changing the machining start point in a direction along the machining vector based on the detection value from the gap sensor.

3. The control device according to claim 1,
wherein the command generation operation by the movement command generation unit and the movement operation of the laser emission mechanism by the main control unit are executed in parallel at the same time.

4. A laser processing device to perform laser machining by irradiating a workpiece with a machining laser beam, the laser processing device comprising:
a workpiece holding mechanism for holding the workpiece;
a laser emission mechanism for emitting the machining laser beam in a direction along a unit vector;
a gap sensor provided in the laser emission mechanism;
a transport mechanism for moving the laser emission mechanism relative to the workpiece holding mechanism; and
a control device to control an operation of each component of the laser processing device,
wherein the control device further includes a main control unit to output a drive command to each component of the laser processing device based on a machining program, and a movement command generation unit to generate a movement command for moving the laser emission mechanism using a detection value from the gap sensor,
the movement command generation unit has a function of generating an approach command for moving the laser emission mechanism from a control start position toward a laser irradiation point on the workpiece to a boundary gap point where the gap sensor starts a detection, and a machining start point movement command for moving the laser emission mechanism from the boundary gap point to a machining start point within a detection range of the gap sensor, and
the machining start point movement command includes a posture change for causing the unit vector at the boundary gap point to coincide with a machining vector at the machining start point.

5. The laser processing device according to claim 4,
wherein the machining start point movement command further includes a distance correction for changing the machining start point in a direction along the machining vector based on the detection value from the gap sensor.

6. The laser processing device according to claim 4,
wherein the command generation operation by the movement command generation unit and the movement operation of the laser emission mechanism by the main control unit are executed in parallel at the same time.

7. A machining start point movement control method for a laser emission mechanism which moves the laser emission mechanism of a laser processing device including the laser emission mechanism for emitting a machining laser beam in a direction along a unit vector and a gap sensor provided in the laser emission mechanism to a machining start point of trace machining control, comprising:
an approach routine for moving the laser emission mechanism from a control start position toward a laser irradiation point on a workpiece to a boundary gap point where the gap sensor starts a detection; and
a machining start point movement routine for moving the laser emission mechanism from the boundary gap point to the machining start point within a detection range of the gap sensor,
wherein the machining start point movement routine includes a posture change step of causing the unit vector at the boundary gap point to coincide with a machining vector at the machining start point.

8. The machining start point movement control method for a laser emission mechanism according to claim 7,
wherein the machining start point movement routine further includes a distance correction step of changing the machining start point in a direction along the machining vector based on a detection value from the gap sensor.

9. The machining start point movement control method for a laser emission mechanism according to claim 7,
wherein in the machining start point movement routine, a generation operation of the movement command for the laser emission mechanism and an actual command output operation are executed in parallel at the same time.
